(19) United States
(12) Patent Application Publication
(10) Pub. No.: US 2024/0132021 A1
(43) Pub. Date: Apr. 25, 2024

(54) APPARATUS AND METHOD FOR CONTROLLING DISCHARGE PRESSURE OF FLUID FOR WASHING A SENSOR

(71) Applicants: HYUNDAI MOTOR COMPANY, Seoul (KR); KIA CORPORATION, Seoul (KR); DY AUTO CORPORATION, Asan-si (KR)

(72) Inventors: Young Joon Shin, Seongnam-si (KR); Chan Mook Choi, Incheon (KR); Gyu Won Han, Incheon (KR); Jong Min Park, Seoul (KR); Jin Hee Lee, Seoul (KR); Jong Wook Lee, Incheon (KR); Min Wook Park, Incheon (KR); Seong Jun Kim, Incheon (KR); Hyeong Jun Kim, Incheon (KR); Sun Ju Kim, Incheon (KR)

(73) Assignees: HYUNDAI MOTOR COMPANY, Seoul (KR); KIA CORPORATION, Seoul (KR); DY AUTO CORPORATION, Asan-si (KR)

(21) Appl. No.: 18/141,607

(22) Filed: Apr. 30, 2023

(30) Foreign Application Priority Data
Oct. 20, 2022 (KR) 10-2022-0136345

(51) Int. Cl. B60S 1/48; G05D 16/20

(52) U.S. Cl. CPC B60S 1/481; G05D 16/2066

(57) ABSTRACT

An apparatus for controlling a discharge pressure of a fluid includes: a pump configured to suck the fluid through an inlet or to discharge the sucked fluid through an outlet; a distributor connected to the pump and to an injection nozzle provided by a sensor and configured to distribute the fluid discharged from the pump to the sensor; and a controller. The controller is configured to control the pump to operate selectively in accordance with detection of contamination of the sensor and to control operation of the distributor to be forcibly delayed during operation of the pump such that the fluid distributed to the sensor, when detected as being contaminated, is controlled to reach a selected required discharge pressure of different required discharge pressures selected in accordance with water amount information and a degree of contamination of the sensor.

### CROSS-REFERENCE TO RELATED APPLICATION

This application claims priority, under 35 U.S.C. § 119(a), to Korean Patent Application No. 10-2022-0136345 filed on Oct. 21, 2022, the entire contents of which are incorporated herein by reference.

### BACKGROUND

### (a) Technical Field

The present disclosure relates to an apparatus and method for controlling a discharge pressure of a fluid for washing a sensor, and more particularly to an apparatus and method for controlling a discharge pressure of a fluid for washing a sensor that is capable of increasing the discharge pressure of the fluid to a predetermined level when a distributor for sensor cleaning is opened.

### (b) Background Art

Recently, in accordance with high advances in autonomous driving technologies, assistive technologies for realizing level-4 technology are highlighted.

One example of such assistive technologies is sensor cleaning for preventing a sensor from malfunctioning due to contamination thereof by rainwater or other contaminants. Fluids mainly used for cleaning the sensor are liquids and air.

When a fluid is injected onto the sensor in order to perform sensor cleaning, the fluid itself may function as a contaminant. For this reason, such sensor cleaning technology may be acceptable only when cleaning of the sensor is achieved as rapidly as possible.

For this reason, for effective sensor cleaning, a fluid and air required in a given situation should rapidly reach a predetermined discharge pressure. When the fluid and air are injected through a nozzle, an injection system may be employed that is configured such that initial injection is carried out at a pressure required in a given situation.

However, the fluid is a viscous fluid and, as such, hydraulic pressure loss of the fluid is inevitably generated due to viscosity until the fluid is discharged to the nozzle after operation of a pump. In addition, the pump compresses the fluid through an impeller in an initial function thereof, thereby creating a hydraulic pressure. In connection with this, the pump requires time to create a desired pressure from a time when the impeller operates initially. For these reasons, there may be a problem of system inefficiency when the fluid is injected.

As a result, such inefficiency may disturb injection of the fluid under a desired pressure in an initial stage of injection. Consequently, problems such as degradation in cleaning performance, an increase in cleaning time, and the like may occur.

### SUMMARY

The present disclosure has been made in an effort to solve the above-described problems associated with the prior art. An object of the present disclosure is to provide an apparatus and method for controlling a discharge pressure of a fluid for washing of a sensor. In the apparatus and method, different drive motor duties of a pump are set based on an amount of water and a degree of contamination of at least one sensor. Further, operation of a distributor together with operation of the pump for washing the sensor are forcibly delayed. A discharge pressure of a fluid injected in an initial stage of injection in operation of the distributor is thereby capable of being increased In other words, the apparatus and method enable the discharge pressure to reach a required discharge pressure in accordance with a selected one of the different drive motor duties, thereby compensating for hydraulic pressure loss generated in a fluid movement path extending from the pump to the distributor for washing the sensor.

Objects of the present disclosure are not limited to the above-described objects. Other objects of the present disclosure not yet described should be more clearly understood by those having ordinary skill in the art from the following detailed description. In addition, objects of the present disclosure may be accomplished by means defined in the appended claims and combinations thereof.

In one aspect, the present disclosure provides an apparatus for controlling a discharge pressure of a fluid. The apparatus includes: a pump configured to suck the fluid through an inlet or to discharge the sucked fluid through an outlet; a distributor connected to the pump and to an injection nozzle provided for at least one sensor and configured to distribute the fluid discharged from the pump to the sensor; and a controller. The controller is configured to control the pump to operate selectively in accordance with detection of contamination of the sensor while controlling operation of the distributor to be forcibly delayed during operation of the pump such that the fluid distributed to the sensor, when detected as being contaminated, is controlled to reach a selected required discharge pressure of different required discharge pressures selected in accordance with water amount information and a degree of contamination of the sensor.

In an embodiment, the controller may control an output of a drive motor of the pump such that the fluid reaches the selected required discharge pressure within a delay time, which is the same as operation of the distributor is being delayed.

In another embodiment, the controller may control a delay time of the distributor such that the fluid reaches the selected required discharge pressure with an output of a drive motor of the pump kept constant.

In another embodiment, the controller may receive information as to contamination of the sensor calculated in an advanced driver assistance system (ADAS). The controller may thereby determine the water amount information of the sensor requiring washing.

In another embodiment, the controller may receive information as to contamination of the sensor calculated in an advanced driver assistance system (ADAS). The controller may thereby determine the degree of contamination of the sensor requiring washing and may perform control to sort a determined degree of contamination to one of a plurality of set labels.

In another embodiment, the controller may receive information as to contamination of the sensor calculated in an advanced driver assistance system (ADAS), may determine a position of the sensor with the contamination information thereof transferred to the controller, and may perform control to selectively add a predetermined weight to the selected required discharge pressure, based on the determined position.

In another embodiment, the controller may receive information as to contamination of the sensor calculated in an advanced driver assistance system (ADAS), may determine an ambient temperature of a vehicle under a condition that the contamination information has been transferred to the controller, and may perform control to selectively add a predetermined weight to the selected required discharge pressure, based on the determined ambient temperature.

In another embodiment, the present disclosure provides a method for controlling a discharge pressure of a fluid. The method includes a first step of determining water amount information of a sensor requiring washing through a controller when information as to contamination of at least one sensor is calculated and then transferred to the controller. The method includes a second step of determining a degree of contamination of the senor requiring washing through the controller and a third step of controlling operation of a pump for discharge of the fluid while controlling operation of a distributor, through the controller. Thus, the fluid distributed to the sensor reaches a selected required discharge pressure of differently set required discharge pressures in accordance with the water amount information and the degree of contamination of the sensor.

In another embodiment, the second step may include sorting the degree of contamination of the sensor to one of a plurality of set labels.

In another embodiment, the third step may include controlling an output of a drive motor equipped in the pump such that the fluid reaches the selected required discharge pressure for a delay time under a condition that operation of the distributor is delayed for the delay time.

In another embodiment, the third step may include controlling a delay time of the distributor such that the fluid reaches the selected required discharge pressure while constantly maintaining an output of a drive motor equipped in the pump under a condition that operation of the distributor is delayed.

In another embodiment, the third step may include receiving information as to contamination of the sensor calculated in an advanced driver assistance system (ADAS), determining a position of the sensor with the contamination information thereof transferred from the ADAS, and performing control to selectively add a predetermined weight to the selected required discharge pressure, based on the determined position.

In another embodiment, the third step may include receiving information as to contamination of the sensor calculated in an advanced driver assistance system (ADAS), determining an ambient temperature of a vehicle under a condition that the contamination information has been transferred, and performing control to selectively add a predetermined weight to the selected required discharge pressure, based on the determined ambient temperature.

Other aspects and embodiments of the disclosure are discussed below.

The above and other features of the disclosure are also discussed below.

In accordance with the embodiments of the present disclosure, different drive motor duties of the pump are set based on different amounts of water and different degrees of contamination of at least one sensor. Operation of the distributor together with operation of the pump for washing of the sensor are forcibly delayed such that the discharge pressure of the fluid injected in an initial stage of injection in operation of the distributor is increased. In other words, the discharge pressure reaches a required discharge pressure in accordance with a selected one of the differently set drive motor duties. Accordingly, there is an effect of compensating for hydraulic pressure loss generated in a fluid movement path extending from the pump to the distributor for washing of the sensor.

Thus, in accordance with the embodiments of the present disclosure, through compensation for hydraulic pressure loss, inefficiency of the sensor washing system may be minimized and a washing time for the sensor may then be reduced.

In addition, in accordance with the embodiments of the present disclosure, the duty value of the drive motor equipped in the pump may be selectively increased, taking into consideration the position of the sensor in the vehicle at which washing is performed, an ambient temperature of the vehicle, and the like. Thus, there is an effect of achieving efficient washing for the sensor according to an increase in the required discharge pressure.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a view showing a configuration of an apparatus for controlling a discharge pressure of a fluid for washing of a sensor in accordance with an embodiment of the present disclosure;

FIG. 2 is a view showing control of a required discharge pressure in the fluid discharge pressure control apparatus for washing the sensor according to the embodiment of the present disclosure;

FIG. 3 is a view sequentially showing a first embodiment of a fluid discharge pressure control method for washing a sensor according to another embodiment of the present disclosure;

FIG. 4 is a view showing setting of a required discharge pressure in the first embodiment of the fluid discharge pressure control method for washing the sensor according to the other embodiment of the present disclosure;

FIG. 5 is a view sequentially showing a second embodiment of the fluid discharge pressure control method for washing the sensor according to the other embodiment of the present disclosure;

FIG. 6 is a view showing setting of a required discharge pressure in the second embodiment of the fluid discharge pressure control method for washing the sensor according to the other embodiment of the present disclosure;

FIG. 7 is a view sequentially showing a third embodiment of the fluid discharge pressure control method for washing the sensor according to the other embodiment of the present disclosure;

FIG. 8 is a view showing setting of a required discharge pressure in the third embodiment of the fluid discharge pressure control method for washing the sensor according to the other embodiment of the present disclosure; and

FIG. 9 is a view sequentially showing a fourth embodiment of the fluid discharge pressure control method for washing the sensor according to the other embodiment of the present disclosure.

The appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes are determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described in detail with reference to the accompanying drawings.

Advantages and features of the present disclosure, and implementation methods thereof, are clarified through the following embodiments described with reference to the accompanying drawings.

The present disclosure may, however, be embodied in different forms and should not be construed as limited to the embodiments set forth herein. Rather, these embodiments are provided so that the disclosure of the present inventive concept is thorough and complete, and fully conveys the scope of the present invention to those with ordinary skill in the art. Furthermore, the present disclosure is only defined by the scope of the claims.

In the following description, where the detailed description of the relevant known technology has been determined to unnecessarily obscure the important point of the present disclosure, the detailed description has been omitted. When a component, device, element, or the like, of the present disclosure is described as having a purpose or performing an operation, function, or the like, the component, device, or element should be considered herein as being “configured to” meet that purpose or to perform that operation or function.

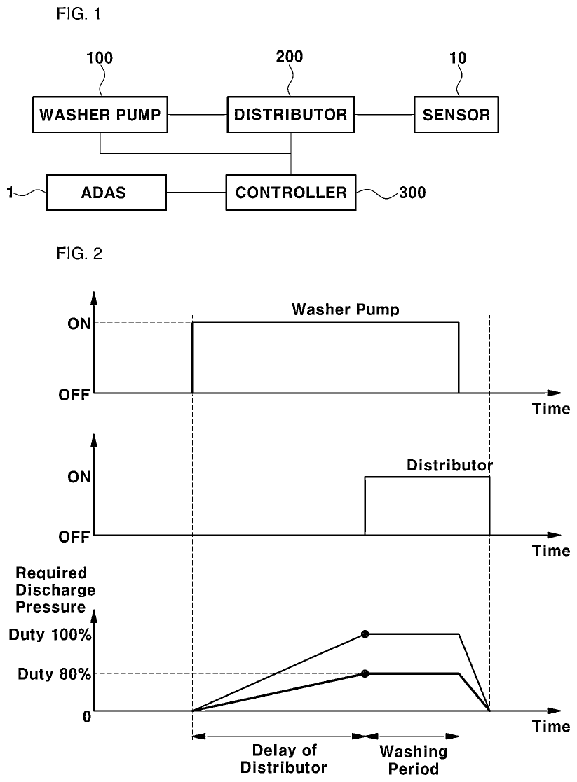

FIG. 1 is a view showing a configuration of an apparatus for controlling a discharge pressure of a fluid for washing a sensor in accordance with an embodiment of the present disclosure. FIG. 2 is a view showing control of a required discharge pressure in the fluid discharge pressure control apparatus for washing the sensor according to the embodiment of the present disclosure.

As shown in FIG. 1, the fluid discharge pressure control apparatus for washing the sensor according to the embodiment of the present disclosure includes a pump 100, a distributor 200, and a controller 300.

The pump 100 is equipped with a drive motor configured to rotate an impeller (not shown) in order to internally suck or draw a fluid stored in a reservoir through an inlet or to discharge the internally-sucked or drawn fluid through an outlet.

The distributor 200 is connected to the pump 100 and an injection nozzle provided at least one sensor 10. The distributor 200 is configured to selectively distribute the fluid discharged from the pump 100 to the sensor 10 such that the fluid may be injected through the injection nozzle, thereby achieving washing of the sensor 10 by the fluid which has a predetermined pressure.

Typically, in washing the sensor 10, hydraulic pressure loss is inevitably generated due to viscosity of the fluid in an initial stage of injection of the fluid until the fluid is discharged through the injection nozzle after operation of the pump 100. In addition, in forming a hydraulic pressure of the fluid by compressing the fluid through the impeller in the pump 100, a certain time is taken to form a desired pressure from a time when the impeller operates initially. Due to such situations, there may be a problem in that a discharge pressure in an initial stage of injection may not reach a required pressure for washing the sensor 10.

Such a problem is generally referred to as “system inefficiency”. In a sensor washing system, the sensor 10 is washed using the fluid and, as such, recognition performance of the sensor 10 is disabled during washing of the sensor 10. Accordingly, it is important to reduce a washing time in order to minimize system inefficiency.

To this end, the controller 300 controls the pump 100 to operate selectively for washing of the sensor 10 in accordance with detection of contamination of the sensor 10 while controlling operation of the distributor 200 to be forcibly delayed during operation of the pump 100, as shown in FIG. 2. Thus, the fluid distributed to the sensor 10, which has been detected as being contaminated, is controlled to reach a selected one of differently set required discharge pressures, i.e., a selected required discharge pressure, in accordance with water amount information and a degree of contamination of the sensor 10, thereby being capable of reducing a washing time.

Contamination information of at least one sensor 10 may be calculated in an autonomous driving system, i.e., an advanced driver assistance system (ADAS) 1. The contamination information may be transferred to the controller 300 which, in turn, may determine water amount information of the sensor 10 requiring washing. In addition, a degree of contamination of the sensor 10 may be sorted as one of a plurality of labels that are set based on the contamination information of the sensor 10 calculated in the ADAS 1.a Thus, the degree of contamination of the sensor 10 may be determined.

For example, the plurality of labels may be designated by “Light”, “Moderate”, and “Heavy” as degrees of contamination corresponding to the labels, which may gradually vary from no contamination to completely contaminated, or various degrees thereof. Accordingly, the controller 300 may selectively sort the degree of contamination of the sensor 10 as one label of the plurality of labels based on the contamination information of the sensor 10 calculated in the ADAS 1. The selected or sorted label may be transferred to the controller 300 such that the degree of contamination of the sensor 10 is determined.

When the pump 100 and the distributor 200 operate simultaneously for washing the sensor 10, the fluid compressed in accordance with operation of the impeller of the pump 100 is distributed to the sensor 10 requiring washing. For this reason, the discharge pressure of the fluid discharged to the sensor 10 during an initial stage of injection is difficult to increase to a required pressure level and, as such, a problem of performance delay may inevitably occur. To this end, operation of the distributor 200 is intentionally delayed through the controller 300 in order to increase the injection-enabling discharge pressure of the fluid in the distributor 200 to a required level.

The controller 300 may control the drive motor equipped in the pump 100 such that the pulse width modulation (PWM) duty value of the drive motor reaches a predetermined discharge pressure set to a duty value of 100%, 80%, or the like, under the condition that operation of the distributor 200 is delayed, i.e., under the condition that the distributor 200 is closed.

Based on such control, the controller 300 enables injection of the fluid under the required discharge pressure from an initial stage of injection in a washing period when operation delay of the distributor 200 is released or terminated, i.e., when the distributor 200 is opened. Accordingly, inefficiency of the sensor washing system as described above may be effectively eliminated.

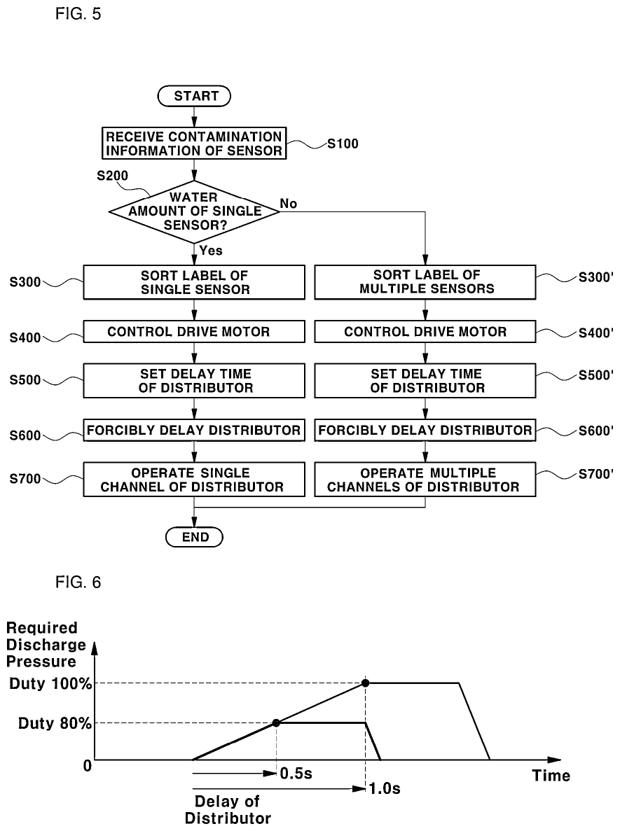

In addition, the controller 300 may control an operation delay time of the distributor 200 such that the fluid reaches the required discharge pressure while controlling the drive motor. Thus, an output of the drive motor is constantly maintained under the condition that operation of the distributor 200 is delayed, i.e., under the condition that the distributor 200 is closed. Accordingly, the output of the drive motor may be continuously increased for the delay time and, as such, injection of the fluid may be performed under the required discharge pressure from the initial stage of injection in the washing period (cf. a description given with reference to FIGS. 5 and 6).

The controller 300, which has received the contamination information of the sensor 10 calculated in the ADAS 1, may determine a position of the sensor 10, the contamination information of which has been transferred to the controller 300. The controller 300 may then perform control to selectively add a predetermined weight to the required discharge pressure, based on the determined position.

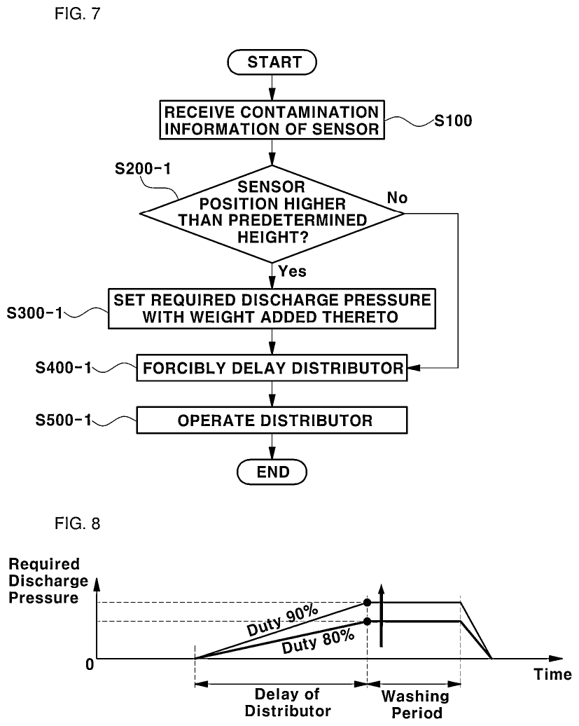

For example, the controller 300 may determine that the position of the sensor 10, the contamination information of which has been transferred from the ADAS 1 to the controller 300, is higher than a predetermined height, i.e., the sensor 10 is disposed at a side of a vehicle roof. Under the condition that the controller 300 controls an output of the drive motor such that the PWM duty value of the drive motor reaches a required discharge pressure set to a duty value of 80%, the controller 300 may then control an output of the drive motor such that the PWM duty value reaches a duty value of 90% by adding a weight of 10% to the required discharge pressure. This is to enable initial injection of the fluid to reach the position at the side of the vehicle roof spaced apart from the pump 100 because the distributor 200 is also disposed in a state of being spaced apart from the pump 100 (cf. a description given with reference to FIGS. 7 and 8).

In addition to reception of contamination information of the sensor 10 calculated in the ADAS 1, the controller 300 may also determine the ambient temperature of the vehicle in a state in which the contamination information has been received. The controller 300 may perform control to selectively add a predetermined weight to the required discharge pressure, based on the determined ambient temperature.

For example, the controller 300 may determine that the ambient temperature of the vehicle measured by a temperature sensor (not shown) is less than 0° C. in a state in which contamination information of the sensor 10 has been transferred from the ADAS 1. Under the condition that the controller 300 controls an output of the drive motor such that the PWM duty value reaches the required discharge pressure set to a duty value of 80%, the controller 300 may then add a weight of 10% to the required discharge pressure This is to control an output of the drive motor such that the PWM duty value reaches 90% because the viscosity of the fluid is low (cf. FIG. 8).

Consequently, in this embodiment, compensation for hydraulic pressure loss generated in a movement path of the fluid extending from the pump 100 to the distributor 200, for washing of the sensor 10, is achieved through the above-described control according to delay of operation of the distributor 200 through the controller 300. As such, inefficiency of the sensor washing system may be minimized and a washing time for the sensor 10 may then be reduced.

In addition, in this embodiment, the duty value of the drive motor equipped in the pump 100 may be selectively additionally increased, taking into consideration the position of the sensor 10 in the vehicle at which washing is performed, ambient temperature of the vehicle, and the like. Thus, efficient washing of the sensor 10 according to an increase in the required discharge pressure may be achieved.

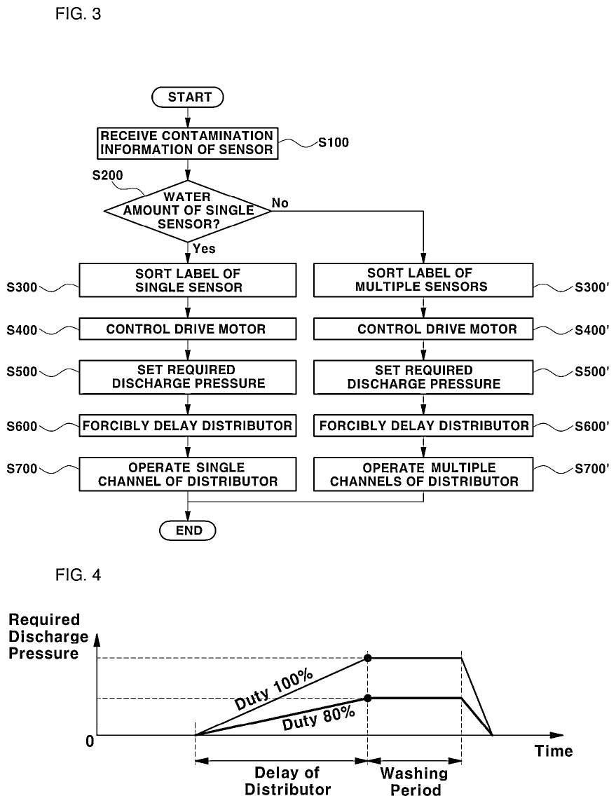

FIG. 3 is a view sequentially showing a first embodiment of a fluid discharge pressure control method for washing a sensor according to another embodiment of the present disclosure. FIG. 4 is a view showing setting of a required discharge pressure in the first embodiment of the fluid discharge pressure control method for washing the sensor according to the other embodiment of the present disclosure.

In addition, FIG. 5 is a view sequentially showing a second embodiment of the fluid discharge pressure control method for washing the sensor according to the other embodiment of the present disclosure. FIG. 6 is a view showing setting of a required discharge pressure in the second embodiment of the fluid discharge pressure control method for washing the sensor according to the other embodiment of the present disclosure.

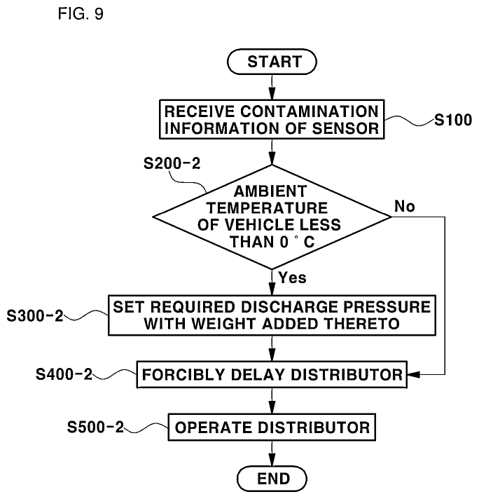

In addition, FIG. 7 is a view sequentially showing a third embodiment of the fluid discharge pressure control method for washing the sensor according to the other embodiment of the present disclosure. FIG. 8 is a view showing setting of a required discharge pressure in the third embodiment of the fluid discharge pressure control method for washing the sensor according to the other embodiment of the present disclosure. FIG. 9 is a view sequentially showing a fourth embodiment of the fluid discharge pressure control method for washing the sensor according to the other embodiment of the present disclosure.

Hereinafter, the first embodiment of the fluid discharge pressure control method for washing of the sensor according to an embodiment of the present disclosure is sequentially described with reference to FIG. 3.

First, when contamination information of at least one sensor 10 is calculated by an ADAS 1 and then transferred to a controller 300 (S100), water amount information of the sensor 10 requiring washing is determined through the controller 300 based on the transferred contamination information (S200).

When the number of sensors 10 requiring washing is, for example, one or two, in accordance with the water amount information, different control operations are performed in accordance with different numbers of the sensors 10. First, when the number of sensors 10 requiring washing is one, a degree of contamination of one sensor 10 is determined through the controller 300 (S300). On the other hand, when the number of sensors 10 requiring washing is two, respective degrees of contamination of two sensors 10 are determined through the controller 300 (S300′). The degree of contamination for more than two sensors may also be conducted according to the teachings of the present disclosure.

Here, a degree of contamination may be sorted as one of a plurality of labels set based on contamination information of the sensor 10 calculated in the ADAS 1. As such, the degree of contamination of the sensor 10 may be determined.

For example, the plurality of labels may be designated by “Light”, “Moderate”, and “Heavy” as degrees of contamination corresponding thereto and may gradually vary by degree between no contamination and completely contaminated.

Accordingly, the controller 300 may selectively sort the degree of contamination of the sensor 10 as one of the plurality of labels based on contamination information of the sensor 10 calculated in the ADAS 1 such that the degree of contamination of the sensor 10 is determined.

Thereafter, a required discharge pressure of a fluid in the distributor 200 is set. For example, when the number of sensors 10 requiring washing is one, and the degree of contamination is “Heavy”, the required discharge pressure may be set by determining a PWM duty value of a drive motor of a pump 100 to be 80% (S400). On the other hand, when the number of sensors 10 requiring washing is two, and the degree of contamination is “Heavy”, the required discharge pressure may be set by determining the PWM duty value of the drive motor to be 100% because the number of sensors 10 requiring washing is increased in a state in which the degree of contamination is still heavy (S400′).

For reference, when, among two sensors 10 requiring washing, the degree of contamination of one sensor 10 is “Heavy” and the degree of contamination of the other sensor 10 is “Moderate”, the required discharge pressure may be set by determining the PWM duty value of the drive motor to be 90% instead of 100%.

When the required discharge pressure is set as described above (S500 or S500′), the controller 300 controls operation of the distributor 200 to be forcibly delayed in a state of operating the pump 100 (S600 or S600′). An output of the drive motor is thereby controlled such that a discharge pressure of the fluid distributed to a single sensor 10 or multiple sensors (for example, two sensors) 10 reaches a selected one of differently set required discharge pressures in accordance with the determined water amount information and the determined degree of contamination, i.e., such that the PWM duty value reaches 80% or 100%, as shown in FIG. 4.

When the number of sensors 10 requiring washing is one, the controller 300 then opens a single channel of the distributor 200 such that the fluid is injected to the sensor 10 in accordance with the drive motor duty value of 80% (S700). On the other hand, when the number of sensors 10 requiring washing is two, the controller 300 then opens two channels of the distributor 200 such that the fluid is injected to the two sensors 10 in accordance with the drive motor duty value of 100% (S700′).

Hereinafter, the second embodiment of the fluid discharge pressure control method for washing of the sensor according to an embodiment of the present disclosure is sequentially described with reference to FIG. 5.

First, when contamination information of at least one sensor 10 is calculated by the ADAS 1 and then transferred to the controller 300 (S100), water amount information of the sensor 10 requiring washing is determined through the controller 300 based on the transferred contamination information (S200).

When the number of sensors 10 requiring washing is, for example, one or two, in accordance with the water amount information, different control operations are performed in accordance with different numbers of the sensors 10. First, when the number of sensors 10 requiring washing is one, a degree of contamination of one sensor 10 is determined through the controller 300 (S300). On the other hand, when the number of sensors 10 requiring washing is two, respective degrees of contamination of two sensors 10 are determined through the controller 300 (S300′).

Here, a degree of contamination may be sorted as one of a plurality of labels set based on contamination information of the sensor 10 calculated in the ADAS 1. As such, the degree of contamination of the sensor 10 may be determined.

For example, the plurality of labels may be designated by “Light”, “Moderate”, and “Heavy” as degrees of contamination corresponding thereto gradually vary as note above. Accordingly, the controller 300 may selectively sort the degree of contamination of the sensor 10 as one of the plurality of a number of labels based on contamination information of the sensor 10 calculated in the ADAS 1 such that the degree of contamination of the sensor 10 is determined.

Thereafter, through the controller 300, an output of the drive motor is controlled to be constantly maintained irrespective of the number of sensors 10 requiring washing (S400 or S400′). Simultaneously, an operation delay time of the distributor 200 is controlled such that the fluid reaches a required discharge pressure. For example, when the number of sensors 10 requiring washing is one, and the degree of contamination is “Heavy”, the operation delay time of the distributor 200 is set to 0.5 seconds (S500). On the other hand, when the number of sensors 10 requiring washing is two, and the degree of contamination is “Heavy”, the operation delay time of the distributor 200 is set to 1 second such that operation of the distributor 200 is further delayed by 0.5 seconds (S500′).

When the operation delay time is further increased in a state in which the output of the drive motor is constantly maintained, as described above, the output of the drive motor is increased for the increased operation delay time. As such, a required discharge pressure may be relatively increased. Thus, when the number of sensors 10 requiring washing is two, and the degree of contamination is “Heavy”, distribution and discharge of the fluid are performed in accordance with a relatively high required discharge pressure because the number of sensors 10 requiring washing is increased in a state in which the degree of contamination is still heavy.

When, among two sensors 10 requiring washing, the degree of contamination of one sensor 10 is “Heavy”, and the degree of contamination of the other sensor 10 is “Moderate”, the controller 300 may set the operation delay time of the distributor 200 to be 0.8 seconds such that operation of the distributor 200 is further delayed by 0.3 seconds.

When the operation delay time of the distributor 200 is set, as described above, the controller 300 controls operation of the distributor 200 to be forcibly delayed for the set operation delay time (S600 or S600′). An output of the drive motor is thereby controlled such that a discharge pressure of the fluid distributed to a single sensor 10 or multiple sensors (for example, two sensors) 10 reaches a selected one of differently set required discharge pressures in accordance with the determined water amount information and the determined degree of contamination, i.e., such that the PWM duty value reaches 80% or 100%, as shown in FIG. 6.

When the number of sensors 10 requiring washing is one, the controller 300 then opens a single channel of the distributor 200 such that the fluid is injected to the sensor 10 in accordance with the drive motor duty value of 80% (S700). On the other hand, when the number of sensors 10 requiring washing is two, the controller 300 then opens two channels of the distributor 200 such that the fluid is injected to the two sensors 10 in accordance with the drive motor duty value of 100% (S700′).

In addition, as shown in FIGS. 7-9, effective washing may be achieved for one sensor requiring washing by adding a weight to a set or selected required discharge pressure for discharge of the fluid.

In other words, as shown in FIG. 7, when contamination information of at least one sensor 10 is calculated by the ADAS 1 and then transferred to the controller 300 (S100), the controller 300 determines the position of the sensor 10, the contamination information of which has been transferred (S200-1).

For example, as shown in FIG. 8, the controller 300 may determine that the position of the sensor 10, the contamination information of which has been transferred from the ADAS 1 to the controller 300, is higher than a predetermined height, i.e., the sensor 10 is disposed at a side of a vehicle roof. Under the condition that the controller 300 controls an output of the drive motor such that the PWM duty value of the drive motor reaches a required discharge pressure set to a duty value of 80% (S200-1), the controller 300 may then set a required discharge pressure such that a weight of, for example, 10%, is added to a drive motor duty value of 80%, which is the required discharge pressure (S300-1). This is to enable initial injection of the fluid to reach the position at the side of the vehicle roof spaced apart from the pump 100 because the distributor 200 is also disposed in a state of being spaced apart from the pump 100. The controller 300 then forcibly delays operation of the distributor 200 such that the set required discharge pressure with the weight added thereto reaches a drive motor duty value of 90% (S400-1). The controller 300 subsequently controls operation of the distributor 200 for discharge of the fluid (S500-1).

Alternatively, after receiving contamination information of the sensor 10 calculated in the ADAS 1, the controller 300 may determine the ambient temperature of the vehicle in a state in which the contamination information has been transferred to the controller 300 (S200-2). The controller 300 may then perform control to selectively add a predetermined weight to the required discharge pressure, based on the determined ambient temperature.

For example, as shown in FIG. 9, the controller 300 may determine that the ambient temperature of the vehicle measured by a temperature sensor (not shown) is less than 0° C. in a state in which contamination information of the sensor 10 has been transferred from the ADAS 1. Under the condition that the controller 300 controls an output of the drive motor such that the PWM duty value reaches the required discharge pressure set to 80% (S200-2), the controller 300 may then set the required discharged pressure such that a weight of, for example, 10%, is added to a drive motor duty value of 80%, which is the required discharge pressure (S300-2). The controller 300 then forcibly delays operation of the distributor 200 such that the set or selected required discharge pressure with the weight added thereto reaches a drive motor duty value of 90% (S400-2), as shown in FIG. 8. The controller 300 subsequently controls operation of the distributor 200 for discharge of the fluid (S500-2).

In accordance with the present disclosure, different drive motor duties of the pump are set or selected based on different amounts of water and different degrees of contamination of at least one sensor. Operation of the distributor together with operation of the pump for washing the sensor are forcibly delayed such that the discharge pressure of the fluid injected in an initial stage of injection in operation of the distributor is increased, i.e., such that the discharge pressure reaches a required discharge pressure in accordance with a selected one of the differently set drive motor duties. Accordingly, there is an effect of compensating for hydraulic pressure loss generated in a fluid movement path extending from the pump to the distributor for washing the sensor.

Thus, through compensation for hydraulic pressure loss, inefficiency of the sensor washing system may be minimized and a washing time for the sensor may then be reduced.

In addition, the duty value of the drive motor equipped in the pump may be selectively increased, taking into consideration the position of the sensor in the vehicle at which washing is performed, the ambient temperature of the vehicle, and the like. Thus, there is an effect of achieving efficient washing for the sensor according to an increase in the required discharge pressure.

The technical concepts of the disclosure are described in detail with reference to embodiments thereof. However, it should be appreciated by those of ordinary skill in the art that changes may be made in these embodiments without departing from the principles and spirit of the disclosure, the scope of which is defined in the appended claims and their equivalents.

What is claimed is:

1. An apparatus for controlling a discharge pressure of a fluid, the apparatus comprising:
a pump configured to suck the fluid through an inlet or to discharge the sucked fluid through an outlet;
a distributor connected to the pump and to an injection nozzle provided for a sensor and configured to distribute the fluid discharged from the pump to the sensor; and
a controller configured to control the pump to operate selectively in accordance with detection of contamination of the sensor and to control operation of the distributor to be forcibly delayed during operation of the pump such that the fluid distributed to the sensor, when detected as being contaminated, is controlled to reach a selected discharge pressure of different required discharge pressures selected in accordance with water amount information and a degree of contamination of the sensor.

2. The apparatus according to claim 1, wherein the controller is configured to control an output of a drive motor of the pump such that the fluid reaches the selected required discharge pressure within a delay time, while operation of the distributor is being delayed.

3. The apparatus according to claim 1, wherein the controller is configured to control a delay time of the distributor such that the fluid reaches the selected required discharge pressure with an output of a drive motor of the pump kept constant.

4. The apparatus according to claim 1, wherein the controller receives information as to contamination of the sensor calculated in an advanced driver assistance system (ADAS), thereby determining the water amount information of the sensor requiring washing.

5. The apparatus according to claim 1, wherein the controller is configured to:
receive information as to contamination of the sensor calculated in an advanced driver assistance system (ADAS), thereby determining the degree of contamination of the sensor requiring washing; and
perform control to sort a determined degree of contamination to one of a plurality of set labels.

6. The apparatus according to claim 1, wherein the controller is configured to:
receive information as to contamination of the sensor calculated in an advanced driver assistance system (ADAS);
determine a position of the sensor with the contamination information thereof transferred to the controller; and
perform control to selectively add a predetermined weight to the selected required discharge pressure, based on the determined position.

7. The apparatus according to claim 1, wherein the controller is configured to:
receive information as to contamination of the sensor calculated in an advanced driver assistance system (ADAS);
determine an ambient temperature of a vehicle under a condition that the contamination information has been transferred to the controller; and
perform control to selectively add a predetermined weight to the selected required discharge pressure, based on the determined ambient temperature.

8. A method for controlling a discharge pressure of a fluid, the method comprising:
a first step of determining water amount information of a sensor requiring washing through a controller when information as to contamination of the sensor is calculated and then transferred to a controller;
a second step of determining a degree of contamination of the sensor requiring washing through the controller; and
a third step of controlling operation of a pump for discharge of a fluid while controlling operation of a distributor, through the controller, such that the fluid distributed to the sensor reaches a selected required discharge pressure of differently set required discharge pressures in accordance with the water amount information and a degree of contamination of the sensor.

9. The method according to claim 8, wherein the second step includes sorting the degree of contamination of the sensor to one of a plurality of set labels.

10. The method according to claim 8, wherein the third step includes controlling an output of a drive motor equipped in a pump such that the fluid reaches the selected required discharge pressure for a delay time under a condition that operation of the distributor is delayed for the delay time.

11. The method according to claim 8, wherein the third step includes controlling a delay time of the distributor such that the fluid reaches the selected required discharge pressure while constantly maintaining an output of a drive motor equipped in the pump under a condition that operation of the distributor is delayed.

12. The method according to claim 8, wherein the third step includes:
receiving information as to contamination of the sensor calculated in an advanced driver assistance system (ADAS);
determining a position of the sensor with the contamination information thereof transferred from the ADAS; and
performing control to selectively add a predetermined weight to the selected required discharge pressure, based on the determined position.

13. The method according to claim 8, wherein the third step includes:
receiving information as to contamination of the sensor calculated in an advanced driver assistance system (ADAS);
determining an ambient temperature of a vehicle under a condition that the contamination information has been transferred; and
performing control to selectively add a predetermined weight to the selected required discharge pressure, based on the determined ambient temperature.
